(19) United States
(12) Patent Application Publication
(10) Pub. No.: US 2008/0292192 A1
(43) Pub. Date: Nov. 27, 2008

(54) HUMAN DETECTION DEVICE AND METHOD AND PROGRAM OF THE SAME

(75) Inventor: Makito SEKI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/943,141

(22) Filed: Nov. 20, 2007

(30) Foreign Application Priority Data
May 21, 2007 (JP) 2007-133783

(51) Int. Cl. G06K 9/48

(52) U.S. Cl. 382/199

(57) ABSTRACT

There is provided a human detection device capable of determining whether a human exists in an infrared image with information only contained in the infrared image at high speed with high accuracy regardless of an ambient environment temperature. The human detection device includes: a boundary information extracting unit which receives infrared image data and detects a boundary of a small image region based on a pixel value of a pixel to specify a boundary pixel; a distance converting unit which calculates a shortest distance between each pixel contained in the small image region and the boundary pixel; a processing unit which extracts a pixel having the shortest distance satisfying a predetermined condition, from the pixels contained in the small image region; and a determining unit which performs pattern matching by comparing image data with a predetermined pattern based on the pixel having the shortest distance to determine whether an object shown in the small image region is a human.

### BACKGROUND OF THE INVENTION

1. Field of the Invention

The present invention generally relates to an object detecting technique, and more particularly, to a device and method for recognizing existence and a position of a human in an infrared image.

2. Description of the Related Art

Conventionally, there has been studied about a technique for recognizing the existence of a specific object in an image based on image data and the like provided by an imaging device and the like. Based on the findings, a human detecting device mounted on a car has been put to practical use. In such human detecting device, a method of detecting the existence of a human based on data obtained using an infrared camera as the imaging device (and another sensor) is used.

There are a variety of different methods of detecting a human. Each of these methods commonly includes a human determining step of determining whether image information which is contained in a specific position or region of an obtained image shows a human or not. And changing the specific position or region, this human determining step is repeated.

In general, the obtained image includes many pixels each having pixel value information. Therefore, when the above human determining step is thoroughly carried out for the entire image, calculation takes a lot of time and error detection is increased. Thus, there has been developed a method in which the obtained image is previously processed and a region in which the above human determining step is executed is previously limited to a specific region in the obtained image and the human determining step is executed for that specific region. The method includes a method in which an infrared image taken by an infrared camera is previously processed to extract a region in which the human may exist and the human determining step is executed for that region. JP 2001-108758 A (Patent Document 1), JP 2004-303219 A (Patent Document 2) and JP 2005-267030 A (Patent Document 3) disclose the above method.

The above Patent Documents 1, 2 and 3 disclose a human detecting device, a vehicle surrounding monitoring device, and pedestrian outline extracting device, respectively. According to the devices disclosed in the Patent Documents 1, 2 and 3, a region having a relatively higher luminance than other regions in an infrared image is extracted and a human existence determining step is executed for that region.

Further, according to JP 2002-099997 A (Patent Document 4), JP 2002-362302 A (Patent Document 5), JP 2003-302470 A (Patent Document 6), and JP 2005-157765 A (Patent Document 7), an infrared camera and other sensor(s) are used and a region in an infrared image in which the human existence determining step is to be executed is specified to reduced a calculation time and to prevent error detection.

The above Patent Document 4 discloses a moving object detecting device and the above Patent Document 5 discloses a pedestrian detecting device. According to the devices disclosed in the Patent Documents 4 and 5, an infrared camera and a visible camera such as a CCD (charge-coupled device) camera (corresponding to the above other sensor(s)) are used to detect an object such as a pedestrian. According to those devices, a road region in an infrared image is previously determined based on information obtained from the visible camera and a pedestrian is searched in the road region. Thus, a time required for searching the pedestrian is shortened.

The above Patent Documents 6 and 7 disclose pedestrian detecting devices. According to the devices disclosed in the Patent Documents 6 and 7, an infrared camera and a radar device (corresponding to the above other sensor(s)) are used to detect an object such as a pedestrian. According to those devices, a region in which a pedestrian may exist is previously extracted based on information obtained from the radar device and the human existence is determined for that region. Thus, a time required for searching the pedestrian is shortened.

JP 2005-234694 A (Patent Document 8) discloses a vehicle surrounding monitoring device. According to the device disclosed in the Patent Document 8, a stereo camera and a far infrared sensor are used to detect an object such as a pedestrian. In this device, a pedestrian candidate is extracted from object(s) which is/are recognized three-dimensionally based on information obtained from the stereo camera and it is determined whether the pedestrian candidate is a pedestrian or not based on information from the far infrared sensor.

However, according to the above conventional methods in which only the infrared image from the infrared camera is used to detect a human based on a high-luminance region in the infrared image, detection precision is likely to be lowered during the day in summer as compared with that in winter in which an air temperature is relatively low. Because, the difference between the surface temperature of a human and a surface temperature of his/her ambient environment becomes small during the day in summer and, occasionally, the luminance level correlation between the human and his/her ambient environment is reversed. (See FIG. 8, for example.) In this case, when the boundary of the high-luminance region in the infrared image is assumed to be the outline of a human, it is impossible to detect the human cannot with high accuracy.

According to the conventional method in which the other sensor(s) is used together with the infrared camera and the human existence is determined in the infrared image based on the information from the other sensor(s), it is necessary for the human detecting device to include the other sensor(s) and an element associated with it, which increases the cost and is disadvantageous. Therefore, the problem is that the application of the human detecting device is limited.

### SUMMARY OF THE INVENTION

In view of the above problems, it is an object of the present invention to provide a human detection device at low cost that is capable of determining whether a human exists in an infrared image only with information being contained in the infrared image at high speed and with high accuracy regardless of an ambient environment temperature.

According to an aspect of the present invention, there is provided a human detection device. The human detection device includes: a boundary information extracting unit; a distance converting unit; a processing unit; and a determining unit. The boundary information extracting unit may receive infrared image data and detect a boundary of a small image region based on a pixel value of a pixel constituting the infrared image to specify a boundary pixel. The distance converting unit may calculate a shortest distance between each pixel contained in the small image region except for the boundary pixel and the boundary pixel. The processing unit may extract a pixel having the shortest distance satisfying a predetermined condition, from the pixels contained in the small image region except for the boundary pixel. The determining unit may perform pattern matching by comparing image data with a predetermined pattern based on the pixel having the shortest distance satisfying the predetermined condition to determine whether or not an object shown in the small image region is a human.

According to another aspect of the present invention, there is provided a human detecting method for detecting a human contained in an infrared image by processing infrared image data using a processing device capable of receiving the infrared image data. The human detecting method includes: boundary information extracting; distance converting; extraction processing; and determining. The boundary information extracting includes receiving the infrared image data and detecting a boundary of a small image region based on a pixel value of a pixel constituting an infrared image to specify a boundary pixel. The distance converting includes calculating a shortest distance between each pixel contained in the small image region except for the boundary pixel and the boundary pixel. The extraction processing includes extracting a pixel having the shortest distance satisfying a predetermined condition, from the pixels contained in the small image region except for the boundary pixel. The determining includes performing pattern matching by comparing image data with a predetermined pattern based on the pixel having the shortest distance satisfying the predetermined condition to determine whether or not an object shown in the small image region is a human.

According to still another aspect of the present invention, there is provided a human detection program executable by a processing device capable of receiving infrared image data. This program is for processing the infrared image data by the processing device to detect a human contained in the infrared image data. The program includes a boundary information extracting step of receiving the infrared image data and detecting a boundary of a small image region based on a pixel value of a pixel constituting an infrared image to specify a boundary pixel; a distance converting step of calculating a shortest distance between each pixel contained in the small image region except for the boundary pixel and the boundary pixel; an extraction processing step of extracting a pixel having the shortest distance satisfying a predetermined condition, from the pixels contained in the small image region except for the boundary pixel; and a determining step of performing pattern matching by comparing image data with a predetermined pattern based on the pixel having the shortest distance satisfying the predetermined condition to determine whether or not an object shown in the small image region is a human.

According to the present invention, it is possible to determine existence of a human in an infrared image by using only the infrared image taken with an infrared camera (infrared image taking unit). Since no sensor or the like other than the infrared camera is required for the present human detection device, manufacturing cost thereof can be decreased.

According to the present invention, it is also possible to dramatically shorten time to be taken for human detection due to a dramatically decreased number of pixels to be actually used for determining existence of a human by performing a predetermined preprocess on the infrared image and analyzing the preprocessed infrared image. Therefore, it leads to be capable of realizing a human detection device sufficiently suitable for practical use even when the human detection device is constituted with an inexpensive processing device.

Further, according to the present invention, the human detection is performed by analyzing the preprocessed infrared image based on a novel and inventive algorithm, which is to be described later. Since this algorithm is hardly affected by the temperature of the ambient environment, the human detection can be performed with high accuracy irrespective of conditions of the ambient environment. Other objects and further features of the present invention will be apparent from the following detailed description when read in conjunction with the accompanying drawings.

### BRIEF DESCRIPTION OF THE DRAWINGS

FIG. 1 is a block diagram of a human detection device according to a first embodiment of the present invention;

FIG. 2 is a flowchart of a human detection process according to the first embodiment of the present invention;

FIG. 3A is an example of an infrared image, and FIG. 3B is an example of a skeletonization process for the infrared image shown in FIG. 3A;

FIG. 4A is an example of detection of an edge and detection of a small region, FIG. 4B is an example of shortest distance calculation for each pixel, and FIG. 4C is an example of extraction of skeleton pixels;

FIG. 5 is a block diagram of Variation 1 of the first embodiment;

FIG. 6 is a block diagram of Variation 2 of the first embodiment;

FIG. 7 is a block diagram of a human detection device according to a second embodiment of the present invention;

FIG. 8 is an example of an infrared image; and

FIG. 9 is an example of a pyramid structure of the infrared images shown in FIG. 8.

### DETAILED DESCRIPTION OF THE PREFERRED EMBODIMENTS

Embodiments of the present invention will be described with reference to the accompanying drawings.

### Embodiment 1

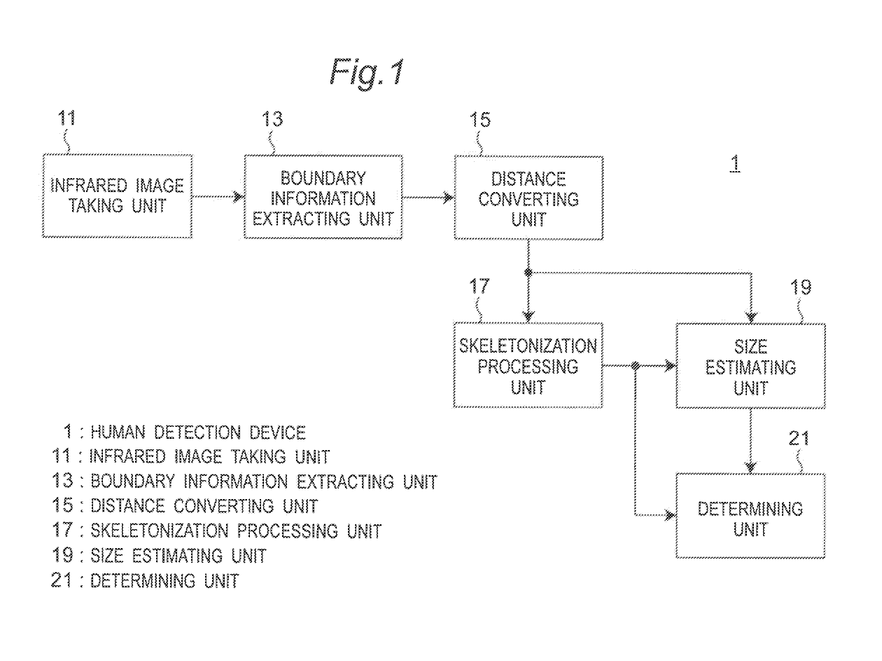

FIG. 1 is a block diagram of a constitution of a human detection device 1 according to a first embodiment of the present invention.

The human detection device 1 includes: an infrared image taking unit 11; a boundary information extracting unit 13; a distance converting unit 15; a skeletonization processing unit 17; a size estimating unit 19; and a determining unit 21. The infrared image taking unit 11 takes a two-dimensional infrared image of a real space and outputs infrared data. The boundary information extracting unit 13 performs preprocessing for distinguishing an edge (side edge part) contained in the infrared image data to generate edge image data and outputs the edge image data. The distance converting unit 15 calculates the shortest distance (edge shortest distance) between each pixel of the edge image data (each pixel of the infrared image data) and a pixel constituting the edge (edge pixel) and outputs it. The skeletonization processing unit 17 extracts a pixel having a maximum value of the edge shortest distance (skeleton pixel) in the infrared image and outputs it. The size estimating unit 19 estimates the size of a human (estimated human size value) assuming that the skeleton pixel is the center of the head of the human, for example with respect to each skeleton pixel based on the edge shortest distance and output it. The determining unit 21 determines whether the skeleton pixel is the pixel showing the center of the head actually or not with respect to each skeleton pixel based on the estimated human size value regarding the skeleton pixel and the edge image data and the like.

The infrared image taking unit 11 may be an infrared camera. Furthermore, it is preferable that the infrared image taking unit 11 is likely to be responsive to a wavelength of a far infrared region. Since the infrared image taken using the far infrared region is preferable because there is a correlation in temperature distribution of an object and information on details of the human such as an eye and nose and the pattern of clothes wanes but the silhouette of the human is clearly obtained.

The boundary information extracting unit 13, the distance converting unit 15, the skeletonization processing unit 17, the size estimating unit 19, and the determining unit 21 can be implemented by a program executed by a general-purpose processor or a processor, or a dedicated communication circuit.

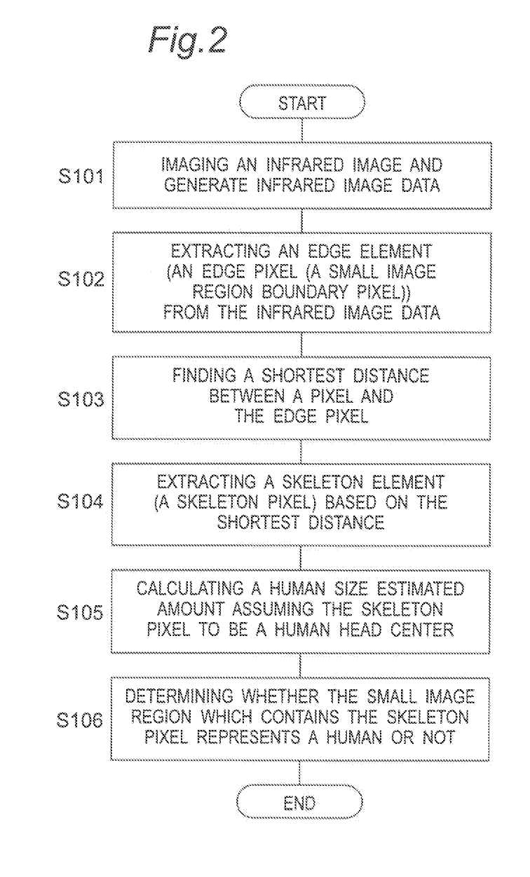

FIG. 2 is a flowchart of human detection according to Embodiment 1 of the present invention.

The infrared image taking unit 11 of the human detection device 1 takes a two-dimensional infrared image of a real space and outputs infrared image data in Step S101.

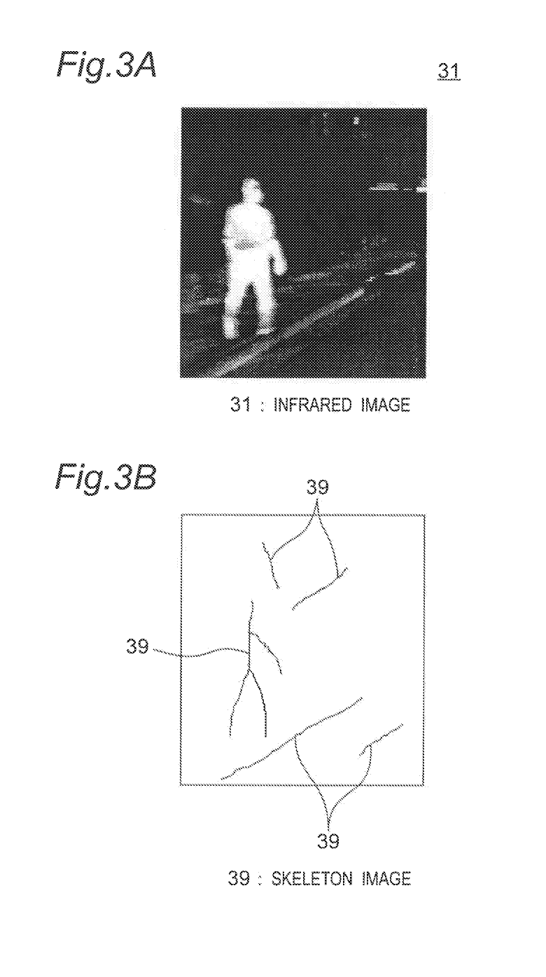

FIG. 3A is a view showing an example of a two-dimensional infrared image 31 taken by the infrared image taking unit 11 in Step S101. Thus, a pedestrian is recorded as an almost uniform region in the two-dimensional infrared image 31.

The boundary information extracting unit 13 of the human detection device 1 receives the infrared image data and performs an edge detecting process for the infrared image data in Step S102. The edge is detected at a position in which a steep, step-like change, for example is generated in the pixel value of each pixel of the infrared image data.

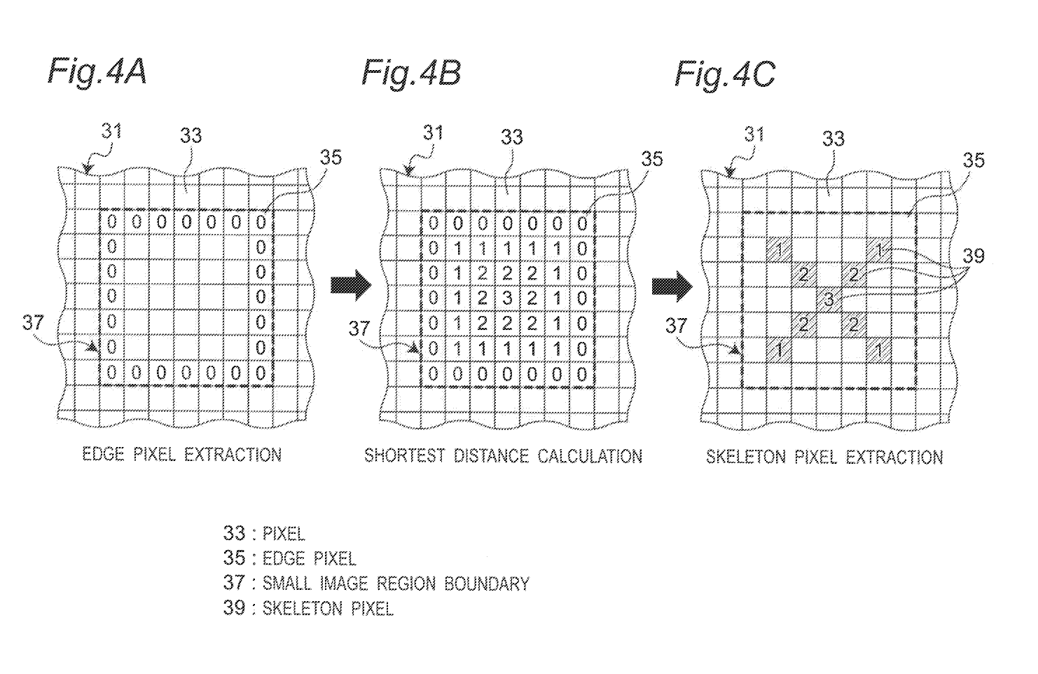

FIG. 4A is a view showing one example of the edge detecting process in the boundary information extracting unit 13. FIG. 4A is a schematic and enlarged view of a part of the infrared image 31, in which the pixel is shown by a square. Thus, the infrared image (infrared image data) 31 includes a plurality of pixels 33. The pixel 33 stores a pixel value showing the gradation sequence of the image. Among these pixels 33, the pixel of which edge is detected by the edge detecting process is called an edge pixel 35 to be distinguished. Information “zero” is allotted to the edge pixel 35.

A well-known method may be used in the edge detecting process in Step S102. Therefore, this will not be described here in detail. For example, a Sobel filer or Laplacian filter may be used to detect the edge.

In Step S103, the distance converting unit 15 of the human detection device 1 calculates the shortest distance between each pixel 33 constituting the infrared image data (strictly speaking, each pixel 33 constituting the infrared image data from which the edge pixel 35 is excluded) and the edge pixel 35.

FIG. 4B is an exemplary view showing a shortest distance calculation result for the pixel 33 surrounded by the edge pixel 35. The edge shortest distance for the edge pixel 35 is zero. According to the present embodiment, the information of “zero” is allotted to the edge pixel 35 in Step S102. The edge pixel 35 is distinguished from other pixels 33 by using the information of the edge pixel 35, and the edge shortest distance of the edge pixel 35 is set to zero.

Next, a description will be made of an example of a calculation method of the edge shortest distance for the pixel 33 of the infrared image 31 except for the edge pixel 35.

According to the present invention, the measure used in calculating the edge shortest distance is not specifically limited. For example, the edge shortest distance may be a minimum value of the Euclidean distance between the pixel 33 to be evaluated and the boundary (edge pixel 35). Alternatively, the edge shortest distance may be a minimum value of the city block distance (Manhattan distance) between the pixel 33 to be evaluated and the boundary (edge pixel 35). Alternatively, the edge shortest distance may be a minimum value of the chessboard distance between the pixel 33 to be evaluated and the boundary (edge pixel 35).

The edge shortest distance is calculated using the above measure and its result is recorded with respect to each pixel. Thus, as shown in FIG. 4B, the edge shortest distance is determined for all pixels 33 surrounded by the edge pixel 35. Although the edge shortest distance for the pixel that is not surrounded by the edge pixel 35 is not shown in FIG. 4, the edge shortest distance for all the pixels 33 constituting the infrared image 31 can be determined at the time of completion of Step S103.

In Step S104, the skeletonization processing unit 17 of the human detection device 1 extracts the “skeleton” contained in the infrared image based on the information on the edge shortest distance.

The “skeleton” contained in the infrared image is a group of the pixels 33 satisfying a predetermined condition. Here, the pixels 33 satisfying the predetermined condition is called “skeleton pixel”. That is, the “skeleton” is the group of the pixels having the “skeleton pixels”. The skeleton pixel is extracted by determining whether the pixel 33 satisfies the predetermined condition or not with respect to each pixel 33 (strictly speaking, the pixel 33 from which the edge pixel 35 is excluded from the pixel 33 constituting the infrared image data.

As the predetermined condition, a condition that “the edge shortest distance of the pixel to be evaluated is not less than the edge shortest distance of the pixels immediately positioned upper, lower, right, and left sides of that pixel” may be used. In this case, the skeleton pixel is farther from the nearest edge pixel 35 as compared with the four pixels immediately positioned upper, lower, right, and left sides of the skeleton pixel. That is, the skeleton pixel is the nearest pixel to the center part of a small image region containing the skeleton pixel as compared with the four pixels immediately positioned upper, lower, right, and left sides thereof. Alternatively, comparison may be made with eight pixels added by pixels immediately positioned obliquely.

FIG. 4C is an exemplary view showing the result of extracting the skeleton pixels 39 based on the above condition. In this drawing, the skeleton pixels 39 are shown by slanted lines.

FIG. 3B is a view showing distribution of the skeleton pixels 39 corresponding to the infrared image 31 shown in FIG. 3A. Thus, the pixel satisfying the predetermined condition is extracted from the pixels 33 in the infrared image 31 as the skeleton pixel 39 in Step S104. Although the skeleton pixels 39 are shown by “black” and the other pixels 33 are shown by “white” schematically in a binary manner in FIG. 3B, the human detection device 1 can store the information on the edge shortest distance with respect to each skeleton pixel 39.

The size estimating unit 19 of the human detection device 1 assumes that the skeleton pixel 39 to be evaluated is the center of the head of the human with respect to each skeleton pixel 39 in the infrared image 31 and estimates the size of the head in the infrared image 31 (estimated human size value) in Step S105. The luminance of the infrared image 31 is closely related to the surface temperature of the object existing in the real space. When the object is the human, the detail configuration (eye or hose) and the pattern of the clothes of the human hardly affects the luminance of the infrared image 31. Based on this fact, the human is detected assuming that the head center of the human is contained in the skeleton pixel 39 in the present invention.

The estimation in this step uses the edge shortest distance stored for each skeleton pixel 39.

For example, when the edge shortest distance stored for the skeleton pixel 39 to be evaluated is “1”, it is estimated that the size of the human head around the skeleton pixel 39 as a center (estimated human size value) corresponds to “1”. Alternatively, when the edge shortest distance stored for the skeleton pixel 39 to be evaluated is “2”, it is estimated that the size of the human head around the skeleton pixel 39 as a center (estimated human size value) corresponds to “2”. Similarly, the human size value is estimated for the skeleton pixel 39 having the edge shortest distance more than “3”. Thus, the size estimating unit 19 sends the estimated human size value with respect to each skeleton pixel 39.

The determining unit 21 of the human detection device 1 determines whether the human exists or not (human existence determination) based on the estimated human size value regarding each skeleton pixel 39 and the edge image data (information of the edge pixel 35) and outputs its result in Step S106.

More specifically, matching is performed between a template of the human head having the size corresponding to the estimated human size value regarding the skeleton pixel 39, and the small image region containing the skeleton pixel 39 to be evaluated to find the similar degree to a template in the case where the skeleton pixel 39 is the head center. Thus, when the similar degree is more than a predetermined threshold value, it is determined that the human having the size corresponding to the estimated human size value of the skeleton pixel 39 exists in the infrared image 31 on condition that the skeleton pixel 39 is the head center.

For example, pattern matching is performed with the template corresponding to the estimated human size value (1, 2 or 3) assuming that each skeleton pixel 39 is the head center, with respect to each skeleton pixel 39 shown in FIG. 4C. In this case, the similar degree is highest in the pattern matching when the skeleton pixel 39 of which estimated human size value is “3” is the head center. When the similar degree is more than the predetermined threshold value, the determining unit 21 determines that the human having the size corresponding to the estimated human size value “3” exists in the infrared image 31 on condition that the skeleton pixel 39 having the estimated human size value “3” is the head center.

The algorithm of the pattern matching in this step may be a well-known algorithm. When the template matching is performed, the template may be a template regarding the upper body of the human as well as the template regarding the human head.

As described above, the human detection device 1 according to the present embodiment limits the pixel showing the human head center to the skeleton pixel and performs the matching for the skeleton pixel only and outputs the human existence determined result. Therefore, a time for calculation is considerably reduced. Further, since the size of the human in the case where the skeleton pixel is the head center is previously estimated, it is not necessary to perform the matching with a template having different sizes for the one skeleton pixel and the time for the calculation can be considerably reduced. Moreover, since only discontinuity of the luminance of the infrared image 31 is focused on in detecting the edge, the human can be detected with high accuracy even in circumstances in which the surface temperatures of the ambient environment and the human are reversed.

Variation 1

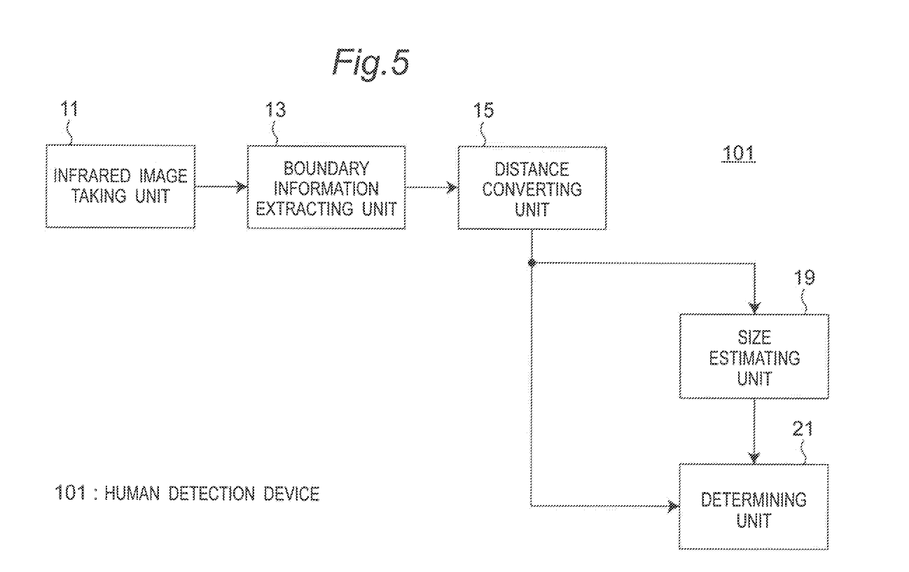

FIG. 5 is a block diagram of a human detection device 101 according to Variation 1 of the first embodiment of the present invention. The human detection device 101 has a constitution in which the skeletonization processing unit 17 is removed from the human detection device 1.

Thus, the human detection device 101 does not perform the skeletonization processing in Step S104 in the flowchart shown in FIG. 2.

A size estimating unit 19 estimates an estimated human size value for a pixel 33 of which edge shortest distance is not less than 1 but not more than a predetermined value, based on the edge shortest distance and outputs it to a determining unit 21.

The determining unit 21 determines whether a human exists or not based on the estimated human size value of the pixel 33 of which edge shortest distance is not less than 1 but not more than the predetermined value and edge image data (information of an edge pixel 35) and outputs its result. The algorithm for determining the existence of the human may be the same as described above.

As described above, the human detection device 101 according to this variation limits the candidate of the pixel showing the human head center, to the pixel of which edge shortest distance is not less than 1 but not more than the predetermined value and performs matching only for that pixel and outputs the determination result of the existence of the human. Therefore, a time for calculation is considerably reduced. Further, since the size of the human in the case where the skeleton pixel is the head center is previously estimated, it is not necessary to perform the matching with a template having different sizes for the one skeleton pixel and the time for the calculation can be considerably reduced. Moreover, since only discontinuity of the luminance of the infrared image 31 is focused on in detecting the edge, the human can be detected with high accuracy even in the circumstances in which the surface temperatures of the ambient environment and the human are reversed.

Variation 2

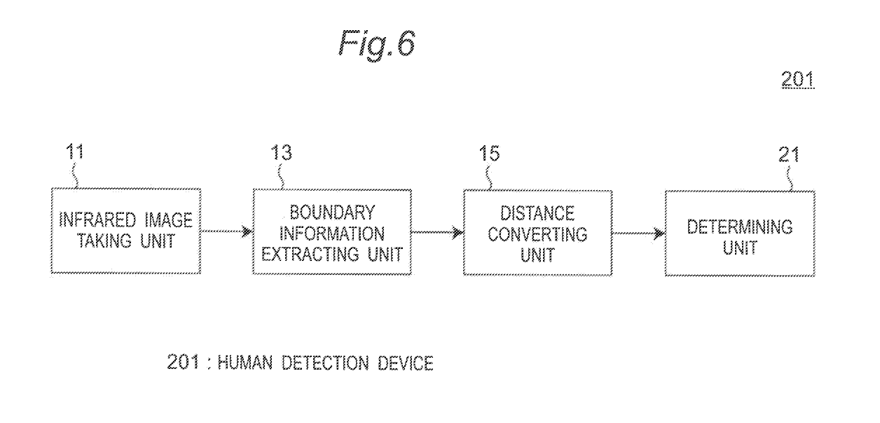

FIG. 6 is a block diagram showing a human detection device 201 according to Variation 2 of the first embodiment of the present invention. The human detection device 201 includes a constitution in which the skeletonization processing unit 17 is removed from the human detection device 1.

Thus, the human detection device 201 does not perform the skeletonization processing in Step S104 and the size estimating process in Step S105 in the flowchart shown in FIG. 2.

A determining unit 21 determines whether a human exists or not based on edge image data (information of an edge pixel 35) of the pixel 33 of which edge shortest distance is not less than 1 but not more than the predetermined value and outputs its result. The algorithm for determining the existence of the human may be the same as described above and in this variation, the size of a template is changed with respect to each pixel and performs matching.

As described above, the human detection device 201 according to this variation limits the candidate of the pixel showing the human head center to the pixel of which edge shortest distance is not less than 1 but not more than the predetermined value and performs matching only for that pixel and outputs the determination result of the existence of the human. Therefore, a time for calculation is considerably reduced. Further, since only discontinuity of the luminance of the infrared image 31 is focused on in detecting the edge, the human can be detected with high accuracy even in the circumstances in which the surface temperatures of the ambient environment and the human are reversed.

### Embodiment 2

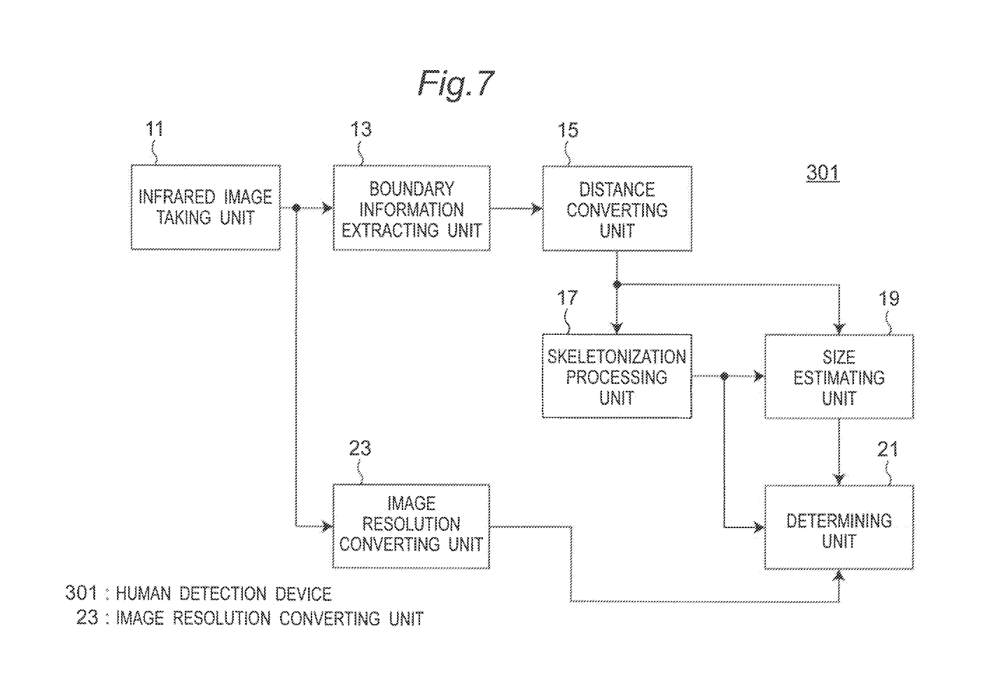

FIG. 7 is a block diagram of a constitution of a human detection device 301 according to a second embodiment of the present invention. The human detection device 301 includes a constitution in which an image resolution converting unit 23 is added to the human detection device 1 shown in FIG. 1.

The image resolution converting unit 23 generates reduced image data of infrared image data outputted from an infrared image taking unit 11 and outputs it to a determining unit 21.

The reduced image data generated by the image resolution converting unit 23 may be image data reduced to ½, ¼, ⅛, . . . of the original infrared image data with respect to horizontal and vertical sizes, for example. The reduced image is generated by performing statistical processing such that pixel values of adjacent 2×2 pixels in horizontal and vertical directions in the original infrared image data are averaged, for example and the averaged value is set to the pixel value of the pixel of the reduced image. The reduced image data generated as described above and the original infrared image data constitute a pyramid structure.

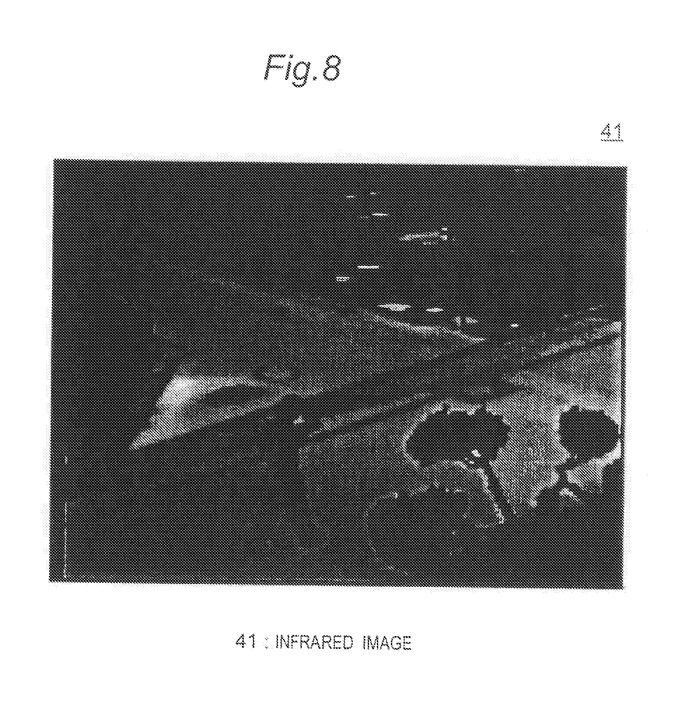

FIG. 8 is an example of an original infrared image 41. The image resolution converting unit 23 reduces the size of the infrared image data and generates the reduced image data.

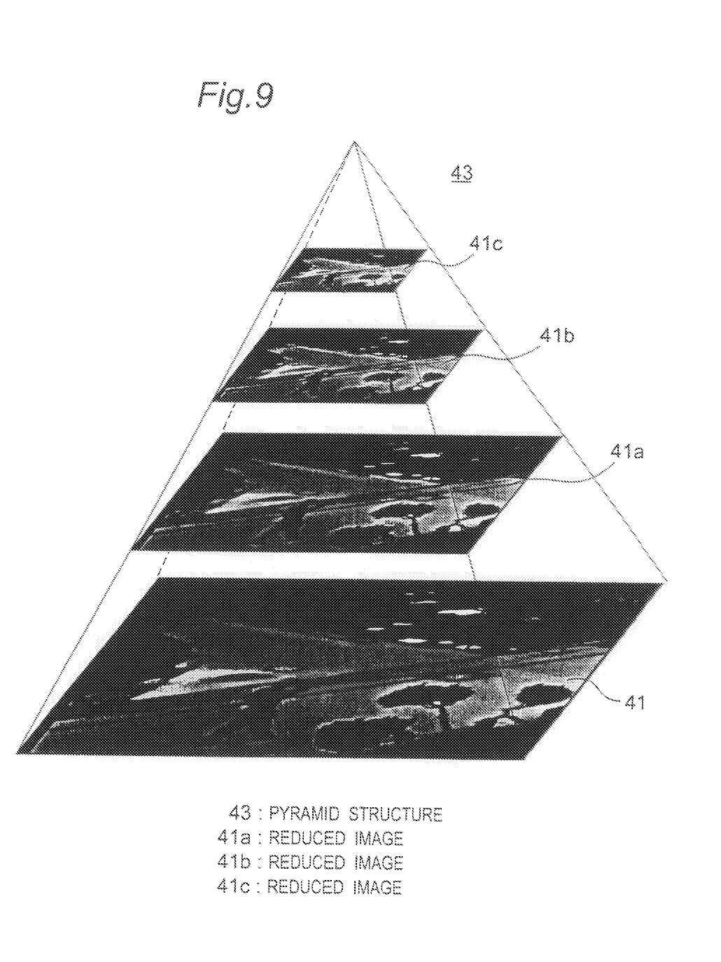

FIG. 9 is a view schematically showing a constitution of a pyramid 43 formed as described above. The original infrared image 41 constitutes the bottom surface of the pyramid 43 and reduced images 41a, 41b and 41c constitute the floors of the pyramid 43.

The determining unit 21 selects the original infrared image 41 or the reduced images 41a, 41b and 41c based on an estimated human size value regarding a skeleton pixel 39 or an edge shortest distance with respect to each skeleton pixel 39 that is to be determined, and performs matching for the selected image data and determines whether a human exists or not.

For example, when the estimated human size value regarding the skeleton pixel 39 to be evaluated (or edge shortest distance) is L, the determining unit 21 determines a maximum N when L/N becomes a predetermined value or more. However, it is to be noted that the N is a numeric sequence (2, 4, 8, 16, . . . ) consisting of power of two.

After determining the N, the determining unit 21 determines whether the human exists or not using data of the reduced image of which vertical and horizontal sizes are reduced to 1/N from the original infrared image 41.

As described above, the human detection device 301 according to Embodiment 2 uses the reduced image data having resolution suitable for the size of the human estimated in the case where the skeleton pixel 39 to be evaluated is the head center, in determining the existence of the human. Since the reduced image data is used, the calculation amount for the pattern matching is reduced and the human existence determining process can be performed at high speed.

Reduction in processing time because the reduced image data is used, and precision in human detection because the reduced image data is used, have a trade-off relation. Therefore, the predetermined value to select the image data (select the resolution of the image) in the human existence determining process is to be determined in view of the precision of the human existence determination and a desired calculation speed.

What is claimed is:

1. A human detection device comprising:
a boundary information extracting unit that receives infrared image data and detects a boundary of a small image region based on a pixel value of a pixel constituting an infrared image to specify a boundary pixel;
a distance converting unit that calculates a shortest distance between each pixel contained in the small image region except for the boundary pixel and the boundary pixel;
a processing unit that extracts a pixel having the shortest distance satisfying a predetermined condition, from the pixels contained in the small image region except for the boundary pixel; and
a determining unit that performs pattern matching by comparing image data with a predetermined pattern based on the pixel having the shortest distance satisfying the predetermined condition to determine whether or not an object shown in the small image region is a human.

2. The human detection device according to claim 1, further comprising:
a size estimating unit that calculates an estimated size value of the object shown in the small image region containing the pixel having the shortest distance satisfying the predetermined condition based on the shortest distance, wherein
the determining unit performs the pattern matching after a size of the predetermined pattern used in the pattern matching is determined based on the estimated size value, or a size of the pattern or the image is adjusted.

3. The human detection device according to claim 2, wherein the predetermined condition is that the shortest distance of the pixel is not less than 1 and not more than a predetermined value.

4. The human detection device according to claim 2, wherein the predetermined condition is that the shortest distance of the pixel is not less than the shortest distances of four pixels immediately positioned upper, lower, right, and left sides of the pixel, or eight pixels further including oblique pixels.

5. The human detection device according to claim 2, further comprising:
an image resolution converting unit that generates a reduced image of the infrared image shown by the infrared image data from the infrared image data at a plurality of reduced levels to output as a plurality of pieces of reduced image data, wherein
the determining unit selects image data to be used in the pattern matching from the infrared image data, image data having an identical resolution as that of the infrared image data and provided by performing a process to the infrared image data, the plurality of reduced image data, and image data provided by performing a process to the plurality of reduced image data, to make determination.

6. A human detecting method of processing infrared image data by a processing device capable of receiving the infrared image data to detect a human contained in the infrared image data, the method comprising:
boundary information extracting that includes receiving the infrared image data and detecting a boundary of a small image region based on a pixel value of a pixel constituting an infrared image to specify a boundary pixel;
distance converting that includes calculating a shortest distance between each pixel contained in the small image region except for the boundary pixel and the boundary pixel;
extraction processing that includes extracting a pixel having the shortest distance satisfying a predetermined condition, from the pixels contained in the small image region except for the boundary pixel; and
determining that includes performing pattern matching by comparing image data with a predetermined pattern based on the pixel having the shortest distance satisfying the predetermined condition to determine whether or not an object shown in the small image region is a human.

7. The human detecting method according to claim 6, further comprising:
size estimating that includes calculating an estimated size value of the object shown in the small image region containing the pixel having the shortest distance satisfying the predetermined condition based on the shortest distance, wherein
the determining performs the pattern matching after a size of the predetermined pattern to be used in the pattern matching is determined based on the estimated size value, or a size of the pattern or the image is adjusted.

8. A human detection program executable by a processing device capable of receiving infrared image data, the program being processing the infrared image data by the processing device to detect a human contained in the infrared image data, the program comprising:
a step of boundary information extracting that includes receiving the infrared image data and detecting a boundary of a small image region based on a pixel value of a pixel constituting an infrared image to specify a boundary pixel;
a step of distance converting that includes calculating a shortest distance between each pixel contained in the small image region except for the boundary pixel and the boundary pixel;
a step of extraction processing that includes extracting a pixel having the shortest distance satisfying a predetermined condition, from the pixels contained in the small image region except for the boundary pixel; and
a step of determining that includes performing pattern matching by comparing image data with a predetermined pattern based on the pixel having the shortest distance satisfying the predetermined condition to determine whether or not an object shown in the small image region is a human.

9. The human detection program according to claim 8, further comprising:
a step of size estimating that includes calculating an estimated size value of the object shown in the small image region containing the pixel having the shortest distance satisfying the predetermined condition based on the shortest distance, wherein
the step of determining performs the pattern matching after a size of the predetermined pattern to be used in the pattern matching is determined based on the estimated size value, or a size of the pattern or the image is adjusted.
